(19) United States
(12) Patent Application Publication
(10) Pub. No.: US 2007/0143296 A1
(43) Pub. Date: Jun. 21, 2007

(54) Taxonomy-based method and system for targeted advertising

(75) Inventor: David Casion, Amherst, NY (US)

Correspondence Address: HODGSON RUSS LLP, ONE M & T PLAZA, SUITE 2000, BUFFALO, NY, 14203-2391, US

(73) Assignee: Kanoodle.com, Inc.

(21) Appl. No.: 11/304,026

(22) Filed: Dec. 15, 2005

(51) Int. Cl. G06F 17/30

(52) U.S. Cl. 707/10

(57) ABSTRACT

A method for filling an impression slot of a web page with a targeted advertisement comprises determining a target context topic associated with the web page's content and a most relevant behavior segment associated with prior browsing behavior of the user, and providing an ad related to the target context topic and/or the most relevant behavior segment. A topical taxonomy is used to ascertain specificity of the target context topic and most relevant behavior segment to allow highly targeted ads to be given priority for filling open impression slots.

### FIELD OF THE INVENTION

The invention relates generally to a system and method for filling impression slots of a web page with targeted advertisements (“ads”) taking into account both content of the web page and web-browsing behavior of a user accessing and displaying the web page on a client computer system connected to a network, such as the Internet.

### BACKGROUND OF THE INVENTION

Computers connected to the Internet may access web pages via a program known as a web browser. Web pages may be constructed in any one of a variety of formatting conventions, such as Hyper Text Markup Language (HTML), and may include multimedia information content such as graphics, audio, and moving pictures. A website may include one or more web pages accessible through a web page often referred to as a “home page.” Commercial and informational websites operated by or on behalf of proprietors are now commonplace. Hyperlinks embedded in the web pages of a web site allow the user to easily navigate through the various web pages of the website.

Consumers and others who “surf” the Internet on client computers often rely on websites known as “search engines” to help them find web pages and websites that are specific to a particular topic or subject area of interest. Search engines allow a user to enter a “keyword” or “search term,” and then the search engine searches a large database of web pages and displays a list of search results comprising links to the listed web pages. In this way, users may locate and navigate to a web page or website of interest. For example, if a user wishes to purchase hockey sticks, the user may enter “hockey sticks” as a search term and the search engine will return a list of web pages, including web pages offering hockey sticks for sale and home pages of websites offering hockey equipment.

In an effort to increase website traffic, website proprietors enlist the services of search engine websites. Search engine websites typically give proprietors the opportunity to display ads in a “sponsored links” region of a search engine web page, and to improve the visibility of a link to the proprietor's website in a list of search results by offering “bid-for-position” accounts, whereby the proprietor pays for each “click-through” generated by the search result listing or ad link. The search engine will store proprietor ads in a database, wherein each ad is assigned a subject area to which the ad is related.

Proprietors may also partner with the search engine to allow the search engine to provide ads for display on the proprietor's website. Because search engines operate by providing advertising services and benefit when an ad is effective in directing a prequalified consumer to a website of interest, search engines seek to fill web page ad space (“impression space”) with ads that are targeted to the user's interests. It is advantageous that the most prominent ad slots (“impression slots”) within an impression space are filled with ads that are targeted with a higher degree of specificity to the user's interests. Moreover, it is advantageous to display ads related to more than one subject area of interest if the user has demonstrated a subject area of interest other than that indicated by a current search.

### SUMMARY OF THE INVENTION

It is therefore an object of the present invention to provide a system and method for enabling search engines to serve an ad for display on a web page, wherein the ad is specifically targeted to an interest of a user viewing the web page.

Another object of the present invention is to provide a system and method for enabling a search engine to determine a first subject area of interest based on content of a web page being viewed on a client computer system, and a second subject area of interest based on previous web pages visited by the client computer system, whereby ads related to the first subject area and ads related to the second subject area may be served to fill impression slots of the web page being viewed.

A further object of the invention is to provide a system and method that ascertains a level of specificity of a subject area of interest so that ads specifically related to the subject area may be given priority for display.

In furtherance of these and other objects, a method of filling an impression slot of a web page displayed by a client computer system according to an embodiment of the present invention generally comprises the steps of determining a target context topic associated with content of the web page; determining a most relevant behavior segment associated with at least one other web page visited by the client computer system; providing an ad related to the target context topic, the most relevant behavior segment, or both the target context topic and most relevant behavior segment; and serving the advertisement for display in the impression slot. The target context topic may be determined by reading and evaluating content, including metatags and text, of the viewed web page. The most relevant behavior segment may be determined by reading data written to a cookie stored on the client computer system and updated during browsing. An ad may be selected by grouping qualified ads relating either to the target context topic or the most relevant behavior segment into an ad pool, and choosing an ad from the pool based on a secondary criterion such as monetary yield associated with each ad. In an embodiment of the invention, a topical taxonomy is used to ascertain specificity of a subject area so that more highly targeted ads may be given priority for display. The invention further encompasses a computer-based system having programming code for carrying out a method of the invention.

### BRIEF DESCRIPTION OF THE DRAWINGS

The nature and mode of operation of the present invention will now be more fully described in the following detailed description taken with the accompanying drawing figures, in which:

FIG. 1 is a schematic block diagram of a network system embodying the present invention;

FIG. 2 shows a search engine web page displayed by a client computer system in accordance with an embodiment of the present invention;

FIG. 3 shows a network partner web page displayed by a client computer system in accordance with an embodiment of the present invention;

FIG. 4 is a partial diagram of a taxonomy used in practicing an embodiment of the present invention;

FIG. 5, which comprises FIGS. 5A and 5B, is a flowchart generally depicting logic flow in accordance with an embodiment of the present invention;

FIG. 6 is a flowchart depicting logic flow of a context target routine referenced in FIG. 5 for determining a target context topic in accordance with the embodiment of FIG. 5; and

FIG. 7 is a flowchart depicting logic flow of a behavior segment routine referenced in FIG. 5 for determining a target behavior segment in accordance with the embodiment of FIG. 5.

### DETAILED DESCRIPTION OF THE INVENTION

Descriptions of specific embodiments are provided only as examples. Various modifications to the described embodiments will be apparent to those skilled in the art, and the general principles defined herein maybe applied to other embodiments without departing from the spirit and scope of the invention. Thus, the present invention is not intended to be limited to the specific embodiments described herein, but is meant to be accorded the widest scope consistent with the principles and features disclosed in this specification.

The following terms used in the specification have the meanings given to them below:

Advertisement: (ad): content, such as, for example, text, images, video clips, and sound clips, capable of display or representation in an impression slot, typically for promoting goods or services and/or linking to a website offering goods or services. An advertisement may be related to a specified subject area corresponding to a behavior segment or a context topic.

Behavior Segment: a subject area associated with one or more websites previously visited by a client computer system. A behavior segment is indicative of web browsing behavior, and may be represented by a corresponding node in a topical taxonomy.

Context Topic: a subject area associated with content of a web page being displayed on a client computer system. A context topic may be represented by a corresponding node in a topical taxonomy.

Impression Slot: a region within an impression space where a single advertisement is displayed or represented.

Impression space: a region or regions where a set of advertisement(s) is displayed or represented. An impression space includes one or more impression slots.

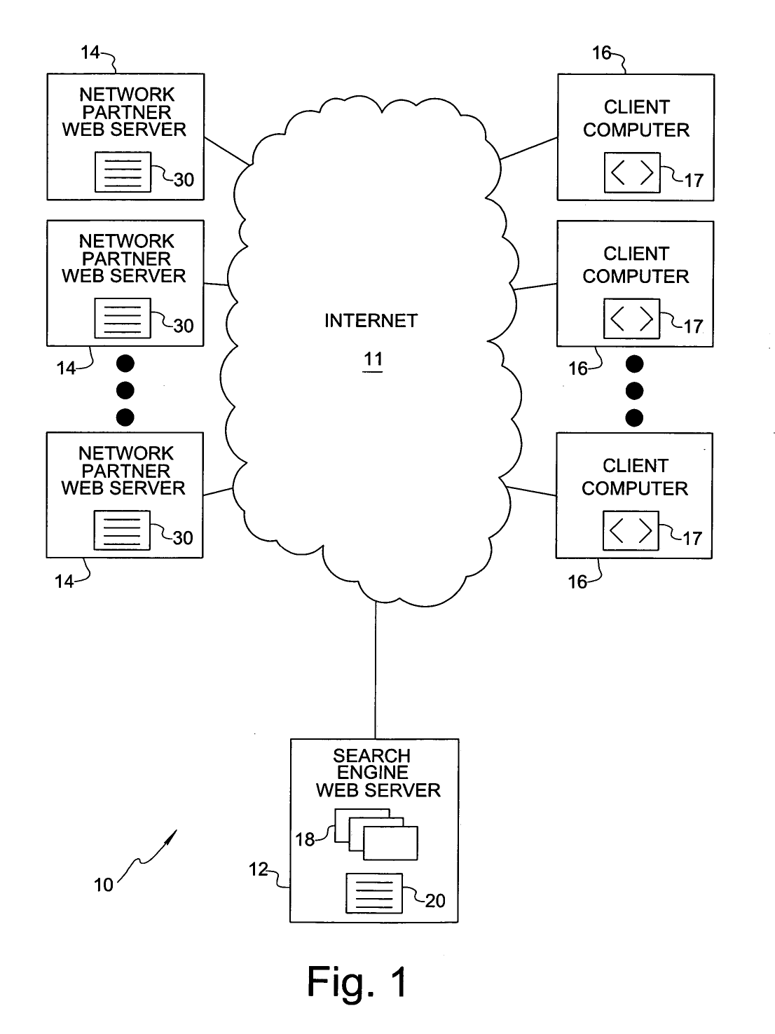

Referring initially to FIG. 1 of the drawings, a computer network system 10 is shown schematically as including a search engine web server 12, a plurality of network partner web servers 14, and a plurality of client computer systems 16, all of which are interconnected to form the computer network system 10. In the embodiment presently described, interconnection of the search engine web server 12, network partner web servers 14, and client computer systems 16 is via the Internet 11, however a LAN (Local Area Network), WAN (Wide Area Network), VPN (Virtual Private Network), or other type of network system may be used for interconnection purposes. Search engine web server 12 stores a search engine database 18 and programming for generating one or more search engine web pages 20 on which search results are displayed. Each network partner web server 14 stores programming for generating a network partner web page 30 that promotes and/or offers goods or services, or provides other information which can be accessed by members of the public using client computers 16 running executable web browser software 17.

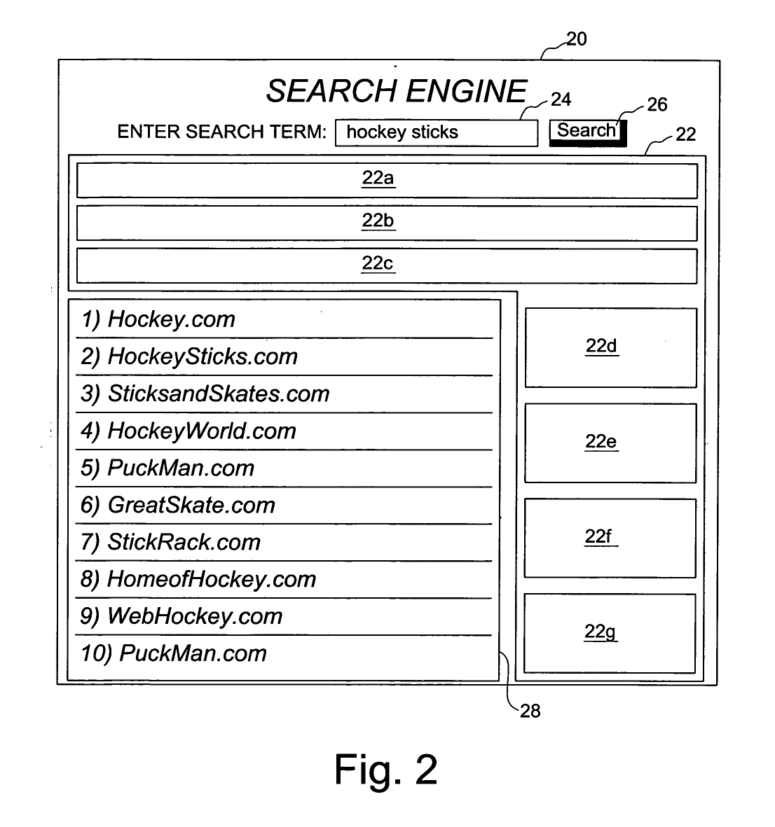

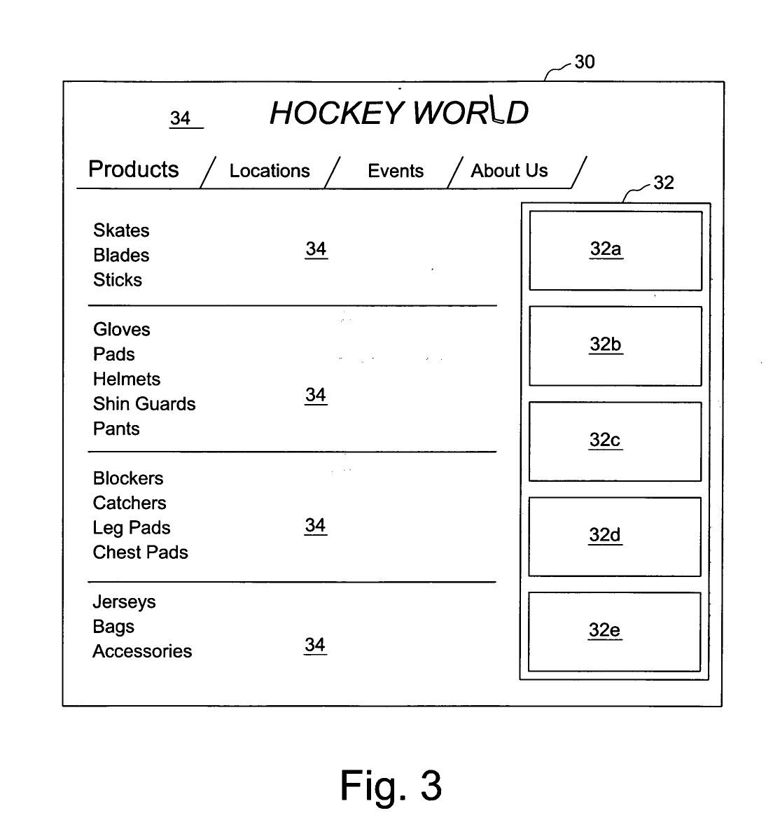

As will be understood by those familiar with the relevant art, and with further reference to FIGS. 2 and 3, a search engine proprietor will affiliate itself with a plurality of network partners. For example, network partners may establish advertising accounts, such as bid-for-position accounts, with a search engine to make it easier for members of the public to locate and link to the network partner's website. As another example, network partners and a search engine may agree to reserve impression space on one another's web pages for displaying advertisements and/or links. Consequently, a search engine web page 20, shown in FIG. 2, may include an impression space 22 having a plurality of impression slots 22a through 22g for displaying “sponsored ads” provided by various network partners. Likewise, a network partner web page 30, shown in FIG. 3, may also include an impression space 32 having a plurality of impression slots 32a through 32e for displaying sponsored ads filled by a search engine or by other network partners. In the case where impression slots 22a-22g or 32a-32e are filled by a search engine, the search engine will fill the slots with ads sponsored by network partners having advertising accounts with the search engine. Because the search engine will typically receive revenue from the ad sponsor each time a member of the public “clicks through” on the ad to the ad sponsor's website, the search engine is economically motivated to fill the impression slots under its control with ads that are related to a topic of interest to the person viewing the web page 20 or 30 on client computer system 16. Two indicators of a relevant topic of interest are: 1) the content of the viewed web page 20 or 30 on which the ads are displayed, and 2) the browsing behavior of the person operating client computer system 16.

As shown in FIG. 2, search engine web page 20 may also include a text box 24 allowing a user to enter a keyword or search term as the basis for a web search initiated when the user clicks a command button 26. A set of search results 28, which typically comprises a plurality ordered links to various web pages retrieved from search engine database 18, may then be displayed on search engine web page 20.

As shown in FIG. 3, network partner web page 30 may further include content spaces 34 for displaying or representing content such as text, images, video clips, and sound clips providing information about the network partner's business or other information (e.g. news, sports, or weather information), and links to other web pages.

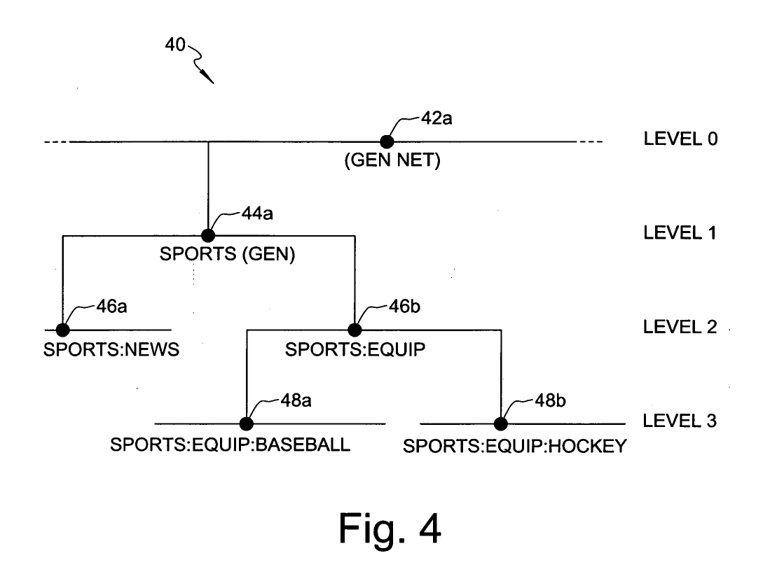

In accordance with methodology of the present invention, one or more of impression slots 22a-22g or 32a-32e may be filled with an ad or ads selected from a pool of ads, wherein at least one of the ads in the pool is related to a context topic associated with content of the viewed web page, and at least one other of the ads in the pool is related to a behavior segment associated with at least one other web page visited by client computer system 16 as indicated by a cookie stored on client computer system 16. Preferably, the context topic and behavior segment are at the same level of specificity in a topical taxonomy, such that the pooled ads have the same level of specificity for targeting prequalified consumers. FIG. 4 schematically illustrates a portion of an example taxonomy 40 that may be used in practicing the present invention. Taxonomy 40 includes a series of levels (Level 0, Level 1, Level 2, Level 3, and so on) of increasing topical specificity. Within Level 0 there is a general network topic node 42a representing a generic source topic. Within Level 1 there are nodes such as 44a that represent a general topic of interest. In the present example, node 44a represents the general topic of sports. The next level, Level 2, includes nodes such as 46a and 46b that represent species of the general topics represented in Level 1. For example, node 46a represents the topic of sports news, while node 46b represents the topic of sports equipment. The next level, Level 3, includes nodes such as 48a and 48b that represent species of the topics represented in Level 2. For example, node 48a represents the topic of baseball equipment and node 48b represents the topic of hockey equipment. As will be appreciated, each of the nodes (except Level 0 node 42a) has one or more “source nodes” from which it is derived. In the present example, nodes 46b, 44a, and 42a are source nodes of node 48b. It will also be understood that, for a given node, there is only one source node in each higher level in the taxonomy. Taxonomy 40 provides a basis or framework for determining a level of specificity of a context topic or a behavior segment.

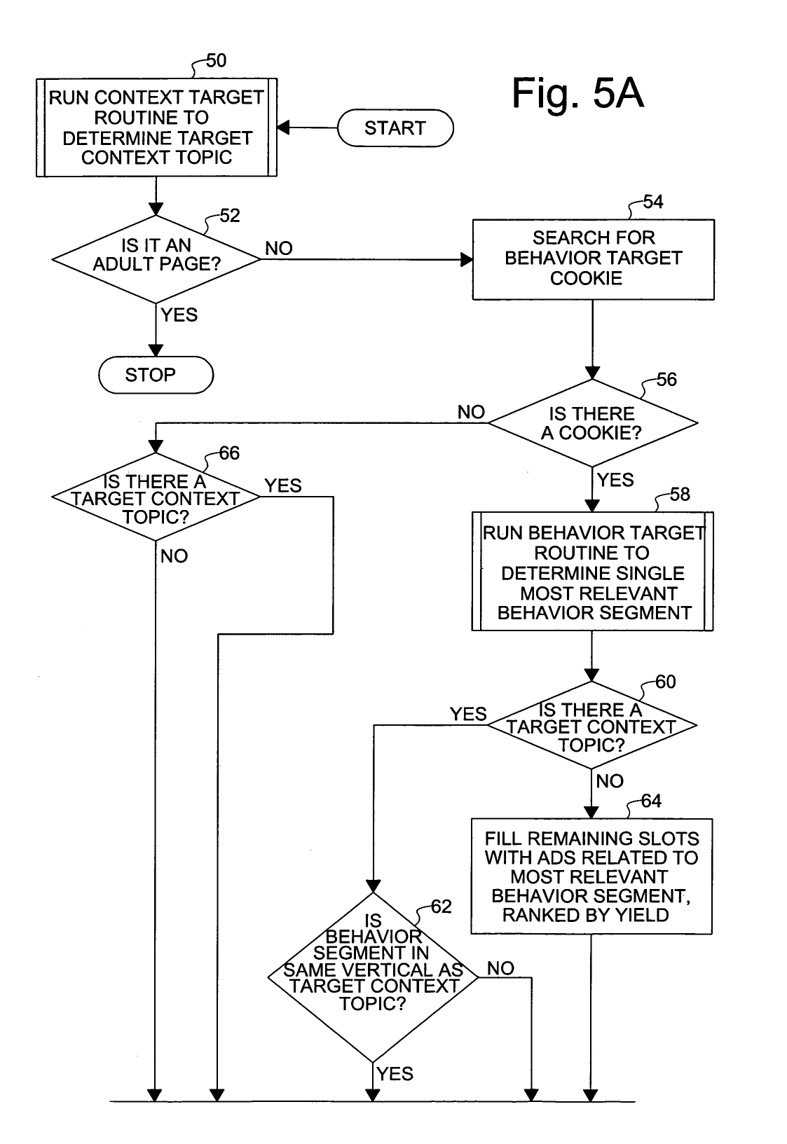

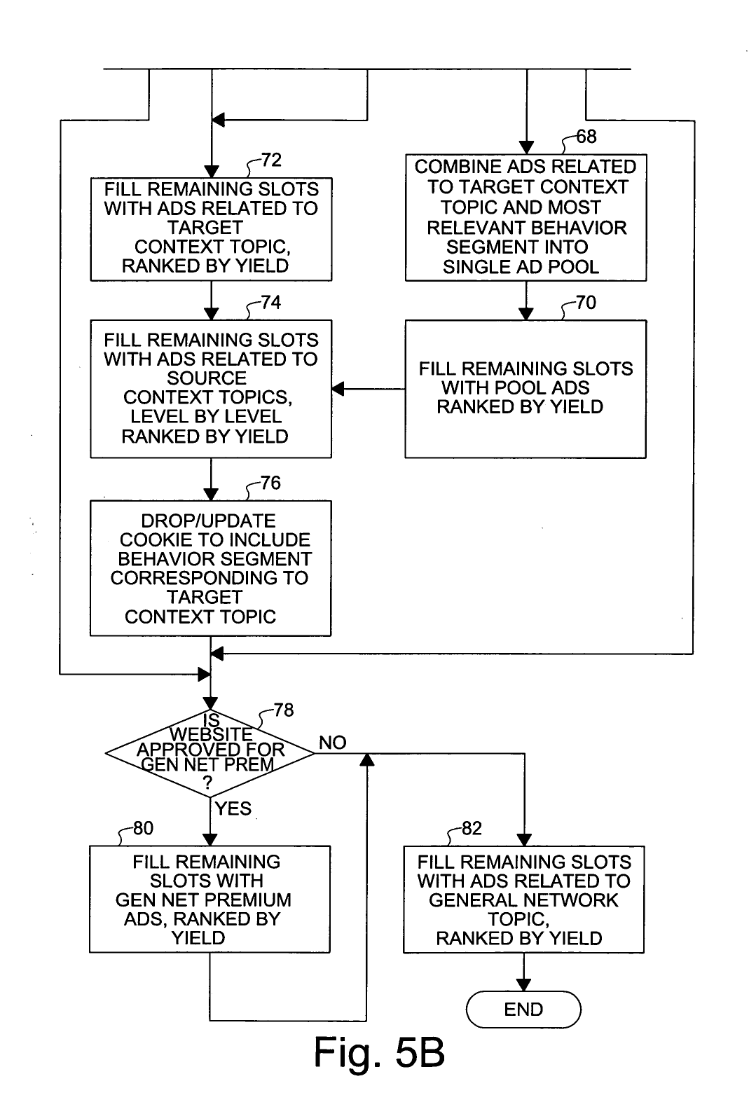

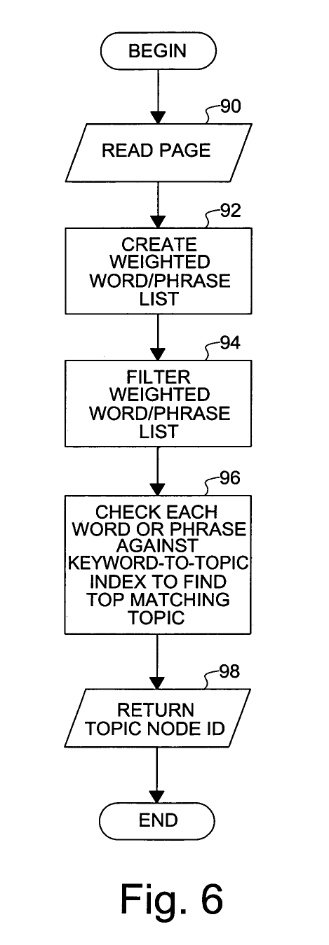

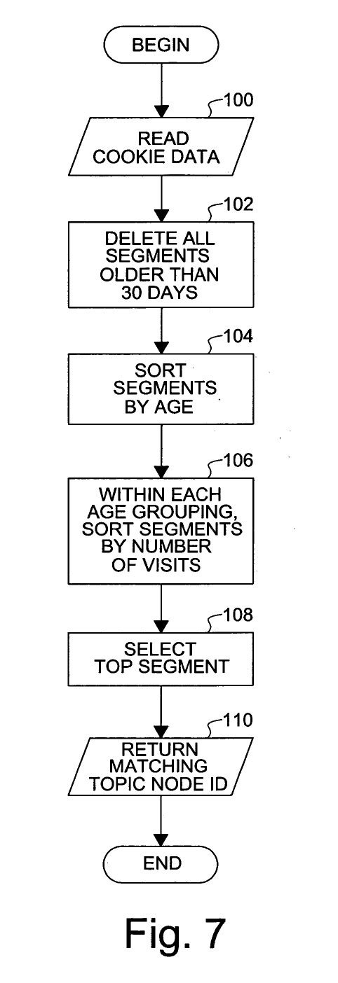

Attention is now directed to the flowchart of FIG. 5, which generally depicts logic flow of programming code for filling impression slots in accordance with an embodiment of the present invention. To facilitate understanding by way of example, it is assumed that the impression slots 32a-32e of network partner web page 30 are being filled for display on client computer 16. Initially, a context target routine is executed under block 50 to determine a target context topic associated with network partner web page 30. A context target routine in accordance with the present embodiment is described below in connection with FIG. 6. The context target routine determines the most relevant topic associated with content on network partner web page 30, which may be identified by reference to a matching topic node in taxonomy 40 if such a matching topic node exists. In the present example, the context target routine returns an identifier of node 48a (sports:equipment:hockey) as the target context topic. Decision 52 allows for special handling of “adult content” web pages. If the target context topic indicates that network partner web page 30 is not an adult content web page, then decision 52 routes flow to block 54, whereby a search is conducted to a cookie stored on client computer system 16, if one exists. If a cookie is located, then decision 56 directs flow to block 58 for execution of a behavior segment routine, shown in greater detail in FIG. 7 and described later herein. The behavior segment routine reads data stored in the located cookie and determines the single most relevant behavior segment indicated by the cookie data. The behavior segment, like the target context topic, may be identified by reference to a matching topic node in taxonomy 40. As will be appreciated, the node corresponding to the behavior segment may or may not be the same as the node corresponding to the target context topic. In other words, the behavior segment and target context topic (if any) may be different.

Flow continues at decision 60, which checks whether a target context topic was found by the context target routine executed in block 50. If the context target finds a matching target context topic in taxonomy 40, then the context target routine identifies a topic node other than general network topic node 42a, decision 60 is answered “YES,” and another decision 62 is executed to determine whether or not the behavior segment is in the same “vertical” as the target context topic in taxonomy 40. A behavior segment and target context topic are considered to be in the same vertical if, in taxonomy 40, the nodes corresponding to the behavior segment and target context topic are both on a single path leading to origin general network node 42a. For example, in taxonomy 40, nodes 48b and 46b are in the same vertical, however nodes 48b and 46a are not. If decision 62 returns “YES,” then flow proceeds to block 72 in FIG. 5B; otherwise, flow branches to block 68 in FIG. 5B.

Where decision 62 returns “YES” and directs flow to block 72, the program will start filling open impression slots 32a-32e by serving ads related to the target context topic (sports:equipment:hockey), if any such ads exist. The impression slots are preferably filled in order, whereby the most prominent impression slot 32a is filled with the ad that provides the highest yield (most revenue) to the search engine according to historical statistics tracked by the search engine, and the next impression slot 32b is filled with the ad providing the next highest yield, and so on. Impression slots are filled under block 72 until either there are no more ads that qualify as being related to the target context topic, or there are no more unfilled impression slots remaining.

After block 72, flow proceeds to block 74. In block 74, any remaining unfilled impression slots are first filled by serving ads related to the topic (sports:equipment) represented by the parent node 46b of target context topic node 48b that is one level up in taxonomy 40, if any such ads exist. Again, open impression slots are preferably filled with ads in order by yield. If more unfilled slots remain, the program will continue with ads related to the topic represented by grandparent node 44a (sports), preferably in order by ad yield. As will be appreciated, the ads served under block 74 are less specific, and thus not as targeted, as the ads served under block 72. The parent node, grandparent node, and so on, are referred to herein as “source nodes” of a given node in taxonomy 40. Impression slots are filled under block 74 until all source nodes up to the original general network node 42a have been processed for matching ads, or there are no more unfilled impression slots remaining.

Next, in block 76, the cookie stored on client computer 16 and located in block 54 is updated by appending behavior segment data to the cookie corresponding to the target context topic associated with network partner web page 30, as determined by the context target routine executed in block 50.

Once block 76 has been executed, any remaining unfilled impression slots are filled. In a currently preferred scheme, the search engine may register “Gen Net Premium” partners whose ads are given priority for display in any remaining impression slots once the original general network node 42a is reached in the slot fill process. Before Gen Net Premium ads are served for display, a check is performed as indicated by decision 78 to determine if network partner web page 30 is approved for display of Gen Net Premium ads. If the quality or other aspects of network partner web page 30 are not palatable to Gen Net Premium partners and/or search engine standards, the network partner web page 30 may not be designated as “approved” for Gen Net Premium ads. In this way, unfilled slots may not be filled by Gen Net Premium ads, and flow jumps to block 82 for filling slots based on ad yield without priority to Gen Net Premium ads. If web page 30 is approved under decision 78, then flow continues at block 80 to fill open impression slots with Gen Net Premium ads ranked by yield, after which flow proceeds to block 82 to fill any remaining unfilled impression slots with ads based on yield.

Returning now to decision 62, the present invention may provide a “pool” of qualified ads if the target context topic and the most relevant behavior segment are not in the same “vertical” in taxonomy 40, thereby making it possible to fill impression slots 32a-32e with ads related to different topics, but nevertheless targeted to the user. Under block 68, ads related to the target context topic and ads related to the most relevant behavior segment are combined into a single pool of ads. In accordance with block 70, the ads in the ad pool are preferably ranked by yield and served, in ranked order, to fill impression slots 32a-32e. In this way, the higher ranked ads are allocated to the more prominent impression slots. Flow is then directed to block 74, discussed above, to start filling any remaining impression slots.

The description now returns to decision 60. If the context target routine executed in block 50 cannot find a matching target context topic in taxonomy 40, then the context target routine simply identifies general network topic node 42a. In that case, decision 60 branches flow to block 64, whereby ads related to the most relevant behavior segment are served for display in impression slots 32a-32e. Preferably, the qualifying ads are ranked by yield and served in ranked order to fill the most prominent available impression slot. Flow then advances to decision 78, described above.

Attention is now directed back to decision 56. If a behavior cookie is not found on client computer system 16, then flow proceeds to decision 66, which is the same test as carried out in decision 60, described above. If a matching target context topic is found by the context target routine, then decision 66 routes flow to block 72. Under block 72, ads related to the target context topic are served for display in impression slots 32a-32e. Preferably, the qualifying ads are ranked by yield and served in ranked order to fill the most prominent available impression slot. Flow then advances to decision 74, described above. If, however, a target context topic cannot be determined by the context target routine, then decision 66 branches program flow to block 78, described above.

A context target routine in accordance with an embodiment of the present invention will now be described with reference to FIG. 6. Generally, the context target routine is called in block 50 of FIG. 5 to evaluate content of a given web page and identify a topic that is most relevant to the web page content. In block 90, the program reads the web page text, including keywords and metatags embedded in the web page. Then, in block 92, the text is parsed to create a list or table of words and phrases that indicates a frequency of use for each word or phrase. The frequency data are preferably weighted by considering attributes of the text, whereby use of a word or phrase as a title, section heading, or link is given greater weight in the frequency count. For example, text used as a title of the page may be counted ten times, text used as a link anchor may be counted three times, and bold text may be counted two times. Next, in block 94, the list of words and phrases is filtered to remove common terms such as “the”, “and”, “I”, “me”, “we”, “you”, etc. that are not indicative of a context topic. Then, in block 96, the words and phrases are checked against a keyword-to-topic cross-index, starting with the most highly weighted word or phrase, to find a top or most relevant matching topic. Finally, in block 98, the routine returns an identifier indicating a node in taxonomy 40 to which the matching topic corresponds. If no matching topic is found, an identifier indicating the general network topic node 42a is returned.

A behavior segment routine in accordance with an embodiment of the present invention will now be described with reference to FIG. 7. Generally, the behavior segment routine is called in block 58 of FIG. 5 to read a cookie stored on client computer system 16 and determine a most relevant behavior segment associated with at least one web page other than the web page currently being viewed. In other words, the behavior segment routine determines a most relevant behavior segment reflected by browsing behavior of a user or users operating client computer system 16. First, the data in the cookie data file are read in accordance with block 100. The data may be organized into one or more data records or data strings each including information representing a behavior segment, a count value indicating the number of visits to websites related to the corresponding behavior segment, the date of the first visit to a website related to the corresponding behavior segment, and the date of the last visit to a website related to the corresponding behavior segment. If a behavior segment has not been visited within the past thirty days, the cookie data corresponding to that behavior segment are deleted from the cookie pursuant to block 102. The remaining segment data are sorted by age in block 104, from the most recently visited behavior segment to the oldest behavior segment in terms of last visitation. For each grouping of behavior segments sharing the same age, the behavior segments within the grouping are sorted secondarily by the number of visits, from most-visited behavior segment to least-visited behavior segment, as indicated by block 106. The top behavior segment is selected in block 108 as being the most relevant behavior segment, and a node identifier representing a node in taxonomy 40 corresponding to the most relevant behavior segment is returned in block 110.

As will be appreciated from the foregoing description, the present invention provides flexibility in the delivery of targeted ads for display by a client computer system by taking into consideration not only the content of the viewed web page on which the ads appear, but also the browsing behavior of a user surfing the web on the client computer system. Consequently, ads related to a context topic may be displayed together with ads related to a behavior segment that differs from the context topic, thereby increasing chances the user will click through to a promoted website. Those skilled in the art will recognize that programming steps and programming flow may be varied from the exact steps and flow described above without departing from the invention defined by the claims herein.

What is claimed is:

1. A method of filling an impression slot of a web page displayed by a client computer system, the web page having a context topic associated with content of the web page and the client computer system having a behavior segment dependent upon at least one cookie stored by the client computer system, the method comprising the steps of:
a) providing a plurality of advertisements, the plurality of advertisements including a pool of advertisements wherein at least one of the advertisements in the pool is related to the context topic and at least one other of the advertisements in the pool is related to the behavior segment; and
b) serving an advertisement selected from the plurality of advertisements for display in the impression slot.

2. The method according to claim 1, wherein the impression slot is one of a plurality of impression slots on the web page, the plurality of impression slots being ordered by prominence on the web page, and one or more of the plurality of advertisements having greatest topical specificity are given priority for display in a most prominent available impression slot.

3. The method according to claim 2, wherein topical specificity of an advertisement is determined by a classification level of a related context topic or related behavior segment in a topical taxonomy.

4. The method according to claim 2, wherein the one or more advertisements having greatest topical specificity are themselves ranked by a secondary criterion, whereby a top-ranked advertisement is selected for display in the most prominent available impression slot.

5. The method according to claim 4, wherein the secondary criterion is an indicator of monetary yield attributed to an advertisement.

6. A method of filling an impression slot of a web page displayed by a client computer system, the method comprising the steps of:
a) determining a target context topic associated with content of the web page;
b) determining a most relevant behavior segment associated with at least one other web page visited by the client computer system;
c) providing an advertisement related to the target context topic, the most relevant behavior segment, or both the target context topic and most relevant behavior segment; and
d) serving the advertisement for display in the impression slot.

7. The method according to claim 6, wherein the step of determining the most relevant behavior segment includes reading a cookie stored on the client computer system.

8. The method according to claim 6, wherein the step of providing an advertisement includes grouping advertisements into a pool, wherein at least one of the advertisements in the pool is related to the target context topic and at least one other of the advertisements in the pool is related to the most relevant behavior segment.

9. A system for filling an impression slot of a web page displayed by a client computer system, the system comprising:
a computer system having stored thereon
programming code for determining a target context topic associated with content of the web page;
programming code for determining a most relevant behavior segment associated with at least one other web page visited by the client computer system;
programming code for providing an advertisement related to the target context topic, the most relevant behavior segment, or both the target context topic and most relevant behavior segment; and
programming code for serving the advertisement for display in the impression slot.

10. The system according to claim 9, wherein the programming code for determining a most relevant behavior segment includes programming code for reading a cookie stored on the client computer system.

11. The system according to claim 6, wherein the programming code for providing an advertisement includes programming code for grouping advertisements into a pool, wherein at least one of the advertisements in the pool is related to the target context topic and at least one other of the advertisements in the pool is related to the most relevant behavior segment.
